(19) United States
(12) Patent Application Publication
(10) Pub. No.: US 2026/0298878 A1
(43) Pub. Date: Oct. 1, 2026

(54) IMAGE-TO-IMAGE TRANSLATION FOR ACOUSTIC INSPECTION

(71) Applicant: Evident Canada, Inc., Québec (CA)

(72) Inventor: Chi-Hang Kwan, Quebec (CA)

(21) Appl. No.: 19/479,266

(22) PCT Filed: Apr. 26, 2024
(86) PCT No.: PCT/CA2024/050554

§ 371 Date: Oct. 27, 2025

Related U.S. Application Data
(60) Provisional application No. 63/499,000, filed on Apr. 28, 2023.

(51) Int. Cl. G01N 29/06; G01N 29/26; G01N 29/44

(52) U.S. Cl. CPC G01N 29/069; G01N 29/262; G01N 29/4481

(57) ABSTRACT

A challenge presented by acoustic imaging techniques, such as generated using a TFM beamforming approach, is that such images do not necessarily provide a representation corresponding to a physical flaw geometry or location. Another challenge is that such imaging does not necessarily appear congruent with a corresponding radiograph of the structure under test. An image-to-image translation approach can be used, such as to perform inversion or otherwise process beamforming output imaging data, to provide flaw identification or mapping in a manner that more closely corresponds to the actual physical location or geometry of corresponding flaws. Such an approach can also (or instead) be used to perform surface profile identification.

### CLAIM OF PRIORITY

This patent application claims the benefit of priority of Chi-Hang Kwan, U.S. Provisional Patent Application No. 63/499,000, titled “TFM DECONVOLUTION USING CONDITIONAL-GENERATIVE ADVERSARIAL NETWORKS,” filed on Apr. 28, 2023 (Attorney Docket No. 6409.245PRV), which is hereby incorporated by reference herein in its entirety.

### FIELD OF THE DISCLOSURE

This document pertains generally, but not by way of limitation, to non-destructive evaluation, and more particularly, to apparatus and techniques for performing feature map generation based on acoustic non-destructive evaluation, using a generative adversarial network applied to an acoustic inspection image generated from a beamforming approach as an input to the generative adversarial network.

### BACKGROUND

Non-destructive testing (NDT) can refer to use of one or more different techniques to inspect regions on or within an object, such as to ascertain whether flaws or defects exist, or to otherwise characterize the object being inspected. Examples of non-destructive test approaches can include use of an eddy-current testing approach where electromagnetic energy is applied to the object and resulting induced currents on or within the object are detected, with the values of a detected current (or a related impedance) providing an indication of the structure of the object under test, such as to indicate a presence of a crack, void, porosity, or other inhomogeneity.

Another approach for NDT can include use of an acoustic inspection technique, such as where one or more electroacoustic transducers are used to insonify a region on or within the object under test, and acoustic energy that is scattered or reflected can be detected and processed. Such scattered or reflected energy can be referred to as an acoustic echo signal. Generally, such an acoustic inspection scheme involves use of acoustic frequencies in an ultrasonic range of frequencies, such as including pulses having energy in a specified range that can include value from, for example, a few hundred kilohertz, to tens of megahertz, as an illustrative example.

### SUMMARY OF THE DISCLOSURE

Acoustic testing, such as ultrasound-based inspection, can include use of individual transducers, or arrays of such transducers including providing focusing or beam-forming techniques to aid in construction of data plots or images representing a region of interest on or within a test specimen. Use of an array of ultrasound transducer elements can include use of a phased-array beamforming approach and can be referred to as Phased Array Ultrasound Testing (PAUT). For example, a delay-and-sum beamforming technique can be used such as including coherently summing time-domain representations of received acoustic signals from respective transducer elements or apertures. A Total Focusing Method (TFM) beamforming technique refers to an approach one or more elements in an array (or apertures defined by such elements) are used to transmit an acoustic pulse and other elements are used to receive scattered or reflected acoustic energy, and a matrix is constructed of time-series (e.g., A-Scan) representations corresponding to a sequence of transmit-receive cycles in which the transmissions are occurring from different elements (or corresponding apertures) in the array.

Such a TFM approach where A-scan data is obtained for each element in an array (or each defined aperture) can be referred to as a “full matrix capture” (FMC) technique. In a manner similar to TFM imaging, a phase-based approach can be used for one or more of acquisition, storage, or subsequent analysis. Such a phase-based approach can include coherent summation of normalized or quantized representations of A-Scan data corresponding to phase information. Such an approach can be referred to as a “phase coherence imaging” (PCI) beamforming technique.

The present inventor has recognized, among other things, that one challenge presented by acoustic imaging techniques, such as generated using a TFM beamforming approach, is that such images do not necessarily provide a representation corresponding to a physical flaw geometry or location. Another challenge is that such imaging does not necessarily appear congruent with a corresponding radiograph of the structure under test. Accordingly, the present inventor has recognized that a machine learning approach can be used, such as to perform inversion or otherwise process beamforming output imaging data to provide flaw identification or mapping in a manner that more closely corresponds to the actual physical location or geometry of corresponding flaws. Such an approach can also (or instead) be used to perform surface profile identification.

In an example, a machine-implemented method can be used for generation of a feature map from acoustic beamforming imaging, the machine-implemented method comprising receiving time-series acoustic inspection data representing acoustic echo signals acquired in response to insonifying an object under test, performing beamforming to generate an image representative of the acoustic inspection data, applying the image as an input to a channel of a generator neural network and, using the generator neural network, generating an output image comprising a feature map corresponding to a physical geometry of the object under test. The applying the image as an input to a channel can include applying different input images representative of the object under test as inputs to different color channels of the generator neural network. For example, the different input images can include an image defining pixel values generated using a Total Focusing Method (TFM) and an image defining pixel values generated using Phase Coherence Imaging (PCI). In another example, the different input images represent different acoustic propagation modes. The machine-implemented method can be defined by instructions stored using a memory circuit, such as executed by a system comprising at least one processor circuit.

This summary is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates generally an example comprising an acoustic inspection system, such as can be used to perform at least a portion one or more techniques as shown and described herein.

FIG. 2 illustrates generally a Generative Adversarial Network (GAN) topology, such as can be used to establish (train or update) a generator neural network, where one or more input channels of the generator neural network can be provided with an acoustic inspection image, and a corresponding feature map can be generated at the output.

FIG. 3A illustrates generally an inspection configuration for obtaining a training and evaluation data set where a test block comprising side-drilled holes is used as an object under test.

FIG. 3B shows an illustrative example of acoustic inspection images generated using two different beamforming techniques applied to inspection data acquired from the same object under test, and an associated labeled feature map representative of the actual physical configuration of the object under test from which acoustic inspection data used for the images was acquired.

FIG. 4A, FIG. 4B, and FIG. 4C show illustrative examples of input images applied to a trained generator neural network, along with an output feature map from the neural network, and a “ground truth” labeled map for comparison, with FIG. 4A showing a single side-drilled hole (SDH) flaw, matching the labeled map, FIG. 4B showing no flaws, matching the labeled map, and FIG. 4C showing a flaw and a surface boundary in the labeled map, and an imperfect output.

FIG. 5A illustrates generally an inspection configuration for obtaining a training and evaluation data set where a test block comprising a flat-bottomed hole (FBH) is used as an object under test.

FIG. 5B shows an illustrative example of acoustic inspection images generated using beamforming corresponding to three different acoustic propagation modes (LLT, TLT, TTT) applied to inspection data acquired from the same object under test, and an associated labeled feature map representative of the actual physical configuration of the object under test from which acoustic inspection data used for the images was acquired.

FIG. 6A, FIG. 6B, FIG. 6C, and FIG. 6D show illustrative examples of input images applied to a trained generator neural network, along with an output feature map from the neural network, and a “ground truth” labeled map for comparison, with FIG. 6A, FIG. 6B, and FIG. 6C showing a flat-bottomed hole (FBH) flaw and surface boundary matching the labeled map, and FIG. 6D showing artifacts in the presence of no flaws in the corresponding labeled map.

FIG. 7 illustrates generally a technique, such as a machine-implemented method, for performing image-to-image translation, such as for generating a feature map corresponding to a physical geometry of an object under test.

FIG. 8 illustrates a block diagram of an example comprising a machine upon which any one or more of the techniques (e.g., methodologies) discussed herein may be performed.

### DETAILED DESCRIPTION

Non-destructive testing of structures can be performed using an acoustic technique, such as involving ultrasonic inspection using a phased-array transducer architecture and associated processing (e.g., beamforming and imaging). As mentioned above, interpretation of acquired inspection data or associated images can present various challenges. Use of Total Focusing Method (TFM) can provide images that are closer to a true geometry, but interpretation of such images is still highly dependent on operator skill, and such imaging does not generally present the same appearance as geometrically-accurate radiography. The present inventor has recognized, among other things, that a deep-learning approach involving the training of a conditional Generative Adversarial Network (cGAN) can be used to provide a generator neural network model that can receive an input image (or multiple such images), such as representing different images (e.g., generated using TFM beamforming) corresponding to different acoustic modes or a combination of TFM and PCI imaging. An output from the generative network can include a feature map (such as showing possible flaw or defect locations) that is geometrically meaningful and more closely aligns with possible flaw or defect locations indicated by radiography, while avoiding use of ionizing radiation associated with radiography.

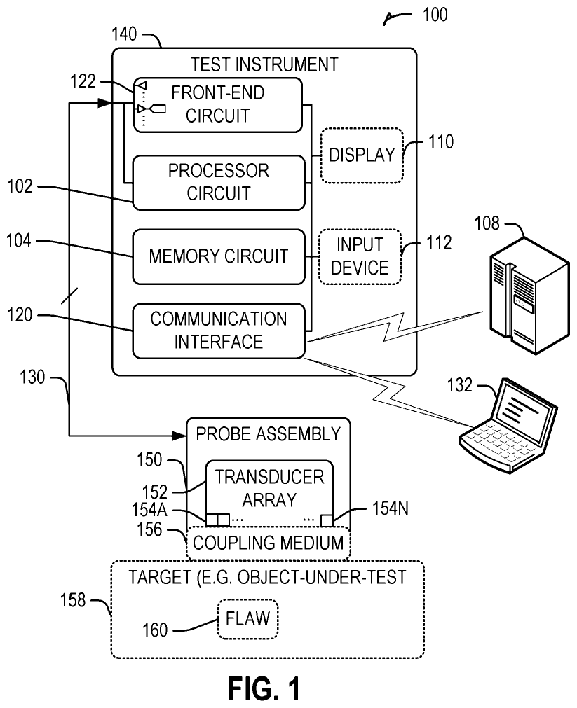

FIG. 1 illustrates generally an example comprising an acoustic inspection system 100, such as can be used to perform at least a portion one or more techniques as shown and described herein. The inspection system 100 can include a test instrument 140, such as a hand-held or portable assembly. The test instrument 140 can be electrically coupled to a probe assembly 150, such as using a multi-conductor interconnect 130. The probe assembly 150 can include one or more electroacoustic transducers, such as a transducer array 152 including respective transducers 154A through 154N. The transducers array can follow a linear or curved contour or can include an array of elements extending in two axes, such as providing a matrix of transducer elements. The elements need not be square in footprint or arranged along a straight-line axis. Element size and pitch can be varied according to the inspection application.

A modular probe assembly 150 configuration can be used, such as to allow a test instrument 140 to be used with various different probe assemblies. Generally, the transducer array 152 includes piezoelectric transducers, such as can be acoustically coupled to a target 158 (e.g., a test specimen or “object-under-test”) through a coupling medium 156. The coupling medium can include a fluid or gel or a solid membrane (e.g., an elastomer or other polymer material), or a combination of fluid, gel, or solid structures. For example, an acoustic transducer assembly can include a transducer array coupled to a wedge structure comprising a rigid thermoset polymer having known acoustic propagation characteristics (for example, Rexolite® available from C-Lec Plastics Inc.), and water can be injected between the wedge and the structure under test as a coupling medium 156 during testing, or testing can be conducted with an interface between the probe assembly 150 and the target 158 otherwise immersed in a coupling medium.

The test instrument 140 can include digital and analog circuitry, such as a front-end circuit 122 including one or more transmitter signal chains, receiver signal chains, or switching circuitry (e.g., transmit/receive switching circuitry). The transmitter signal chain can include amplifier and filter circuitry, such as to provide transmit pulses for delivery through an interconnect 130 to a probe assembly 150 for insonifying the target 158, such as to image or otherwise detect a flaw 160 on or within the target 158 structure by receiving scattered or reflected acoustic energy elicited in response to the insonification.

While FIG. 1 shows a single probe assembly 150 and a single transducer array 152, other configurations can be used, such as multiple probe assemblies connected to a single test instrument 140, or multiple transducer arrays 152 used with a single probe assembly 150 or multiple probe assemblies for pitch/catch inspection modes. Similarly, a test protocol can be performed using coordination between multiple test instruments 140, such as in response to an overall test scheme established from a master test instrument 140 or established by another remote system such as a compute facility 108 or general-purpose computing device such as a laptop 132, tablet, smart-phone, desktop computer, or the like. The test scheme may be established according to a published standard or regulatory requirement and may be performed upon initial fabrication or on a recurring basis for ongoing surveillance, as illustrative examples.

The receiver signal chain of the front-end circuit 122 can include one or more filters or amplifier circuits, along with an analog-to-digital conversion facility, such as to digitize echo signals received using the probe assembly 150. Digitization can be performed coherently, such as to provide multiple channels of digitized data aligned or referenced to each other in time or phase. The front-end circuit can be coupled to and controlled by one or more processor circuits, such as a processor circuit 102 included as a portion of the test instrument 140. The processor circuit can be coupled to a memory circuit, such as to execute instructions that cause the test instrument 140 to perform one or more of acoustic transmission, acoustic acquisition, processing, or storage of data relating to an acoustic inspection, or to otherwise perform techniques as shown and described herein. The test instrument 140 can be communicatively coupled to other portions of the system 100, such as using a wired or wireless communication interface 120.

For example, performance of one or more techniques as shown and described herein can be accomplished on-board the test instrument 140 or using other processing or storage facilities such as using a compute facility 108 or a general-purpose computing device such as a laptop 132, tablet, smart-phone, desktop computer, or the like. For example, processing tasks that would be undesirably slow if performed on-board the test instrument 140 or beyond the capabilities of the test instrument 140 can be performed remotely (e.g., on a separate system), such as in response to a request from the test instrument 140. Similarly, storage of imaging data or intermediate data such as A-scan matrices of time-series data or other representations of such data, for example, can be accomplished using remote facilities communicatively coupled to the test instrument 140. The test instrument can include a display 110, such as for presentation of configuration information or results, and an input device 112 such as including one or more of a keyboard, trackball, function keys or soft keys, mouse-interface, touch-screen, stylus, or the like, for receiving operator commands, configuration information, or responses to queries.

As mentioned above, interpretation of imaging generated by applying beamforming to acquired acoustic inspection data is generally more complicated as compared to geometrically-accurate radiography images. Delay-and-sum approaches such as Total Focusing Method may provide some improvement in ease of interpretation, but in order to generate images that are as readily interpretable as radiography images, an inversion problem may still exist, from an imaging perspective. Use of a machine-learning approach can be helpful in generating geometrically-accurate images when provided with input images such as generated using TFM beamforming.

A machine learning approach can offer a more computationally-efficient approach for inversion as compared to physics-based approaches, and in many cases, a physics-based approach may not be tractable (or even known) for a complex geometric configuration. As an illustration, an image generated based on acquired acoustic inspection data, I(r), where r denotes the pixel location, can be modelled as I(r)=H(r)⊗S(r), where S(r) represents information regarding the sample obtained from the object under test (including flaws and geometry) and H(r) can represent an acoustic response of the system (such as representative of a point spread function or impulse response). A process for recovering S(r) from I(r) can be referred to generally as a deconvolution operation. Deconvolution is difficult to implement in a generalized fashion because H(r) is generally location-dependent, and computationally expensive to model. There may also exist flaw-to-flaw interactions that affect the acoustic response H(r). By contrast, a machine-learning based approach can assist in performing an operation similar to deconvolution where an output feature map can show dimensions and locations of possible flaws or other features such as surface contours in a geometrically-meaningful manner.

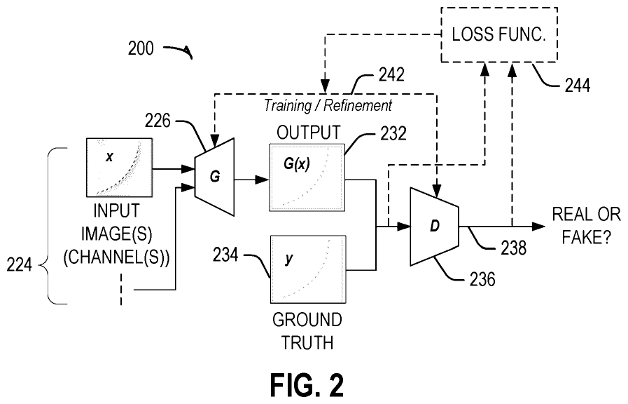

As an illustration, FIG. 2 illustrates generally a Generative Adversarial Network (GAN) topology 200, such as can be used to establish (train or update) a generator neural network 226, where one or more input channels 224 of the generator neural can be provided with an input image, x, and a corresponding translated image, G(x), can be generated at the output 232. A GAN topology can be defined as having two neural networks, a generator neural network 226, G, and a competing discriminator network 236, D. The topology 200 shown in FIG. 2 is referred to as a conditional or “cGAN” topology, where for conditional-GAN, an input, x, is provided. Generally, the input condition, x, can be a simple attribute label or an input image for Image-to-Image mapping, as shown and described in relation to the present subject matter. The goal of the generator neural network 226, G, is to generate a credible (e.g., realistic) image output 232 G(x) given the input condition, x. The goal of the competing discriminator network 236, D, is to correctly classify fake images G(x) from reference images, y, representative of “ground truth,” given the input condition, x. G and D compete during a training process 242 and are refined based on their performance, such as in order to improve each other as measured by one or more loss functions 244 associated with training the generator neural network 226 and the competing discriminator network 236. For example, a loss function can be used to determine a similarity between a generated image G(x), and a reference image, y.

Once the generator neural network 226 has been trained, such as trained using imaging corresponding to an object having a same geometry as the object under test, it can be instantiated separately from the other elements shown in FIG. 2, such as in a production environment after training has been completed. In another approach, the generator neural network 226 can be updated or refined such as by events that trigger additional training, training at specified intervals, or based on other criteria.

As mentioned above, and when viewed from a high level, image deconvolution of acoustic inspection images, such as generated using TFM, can be considered an image-to-image translation problem that can be approached using a cGAN topology 200 as shown in FIG. 2. The input condition can be one or more acoustic inspection images applied to one or more input channels of the generator neural network 226, and the output 232 can represent a feature map (such as showing possible flaw locations or other features of the object under test, such as material boundaries, surface contours, or the like). Training of the topology 200 can include use of a data set comprising tuples of geometrically-accurate maps showing features such as flaw geometry, and corresponding acoustic imaging generated using beamforming. As discussed below, the input images can be provided to different channels (e.g., different color channels) of a generator neural network 226, such as allowing input images constructed using different imaging modes (e.g., TFM versus phase coherence imaging), or representative of different acoustic propagation modes.

For training, generally a ground truth output flaw map, y, is paired with one or more corresponding input images, and in one approach, it could be argued that the competing discriminator network 236, D, could be omitted and a difference metric could be used based on similarity between G(x) and y, alone. However, such an approach may generate blurry images, G(x), at least when using L1-norm as a difference metric. The addition of the competing discriminator network 236, D, adapts the loss metric to better distinguish between G(x) and y. A cGAN training approach can be augmented with L1 difference or other metrics (such as sparsity) to apply a priori knowledge.

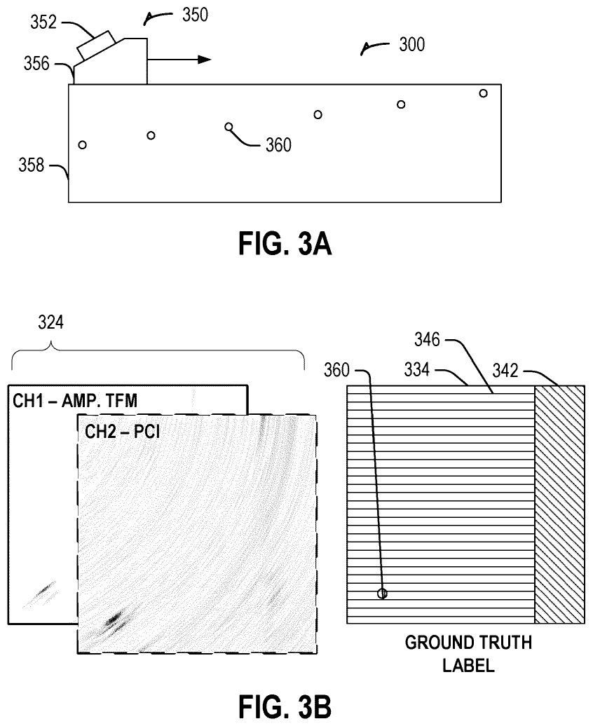

Various examples below show use of different imaging modes and defect classes to provide illustration of the performance of trained generator neural networks for performing feature map generation (e.g., showing flaws) from input images generated using beamforming applied to acquired acoustic inspection data. For example, FIG. 3A illustrates generally an inspection configuration 300 for obtaining a training and evaluation data set where a test block 358 comprising side-drilled holes (SDHs, such as SDH 360) is used as an object under test. The test block 358 used for the illustrative examples herein is a NAVSHIPS 1018 steel metric test block comprising six 1.2 millimeter (mm) diameter SDHs drilled to various depths. A probe assembly 350 used for acquiring acoustic inspection data was a 32-element 5L32-A31 probe 352 coupled to a 36.1° SA31-N55S-IHC wedge 256. Full-matrix capture (FMC) acquisitions were performed in the direction shown by the arrow at one-millimeter intervals along the surface of the test block 358.

FIG. 3B shows an illustrative example of acoustic inspection images 324 generated using two different beamforming techniques applied to inspection data acquired from the same object under test (the test block 358 illustrated in FIG. 3A), and an associated labeled feature map 334 representative of the actual physical configuration of the object under test from which acoustic inspection data used for the images was acquired. As mentioned above, images obtained from different acoustic propagation modes or imaging techniques (TFM vs. PCI) can be provided to different input channels of a generator neural network. Such an approach can provide greater flexibility than deterministic merged-mode procedures (such as pixel-wise addition, max pixel value, pixel-wise multiplication, or the like). Without being bound by theory, the present inventor has recognized that the approaches described herein where different imaging modes or propagation modes are provided as separate inputs may help to suppress mode-conversion artifacts.

For each acquisition, the generated amplitude TFM and PCI input images 324 (e.g., normalized monochromatic provided to separate color channels of a generator neural network) represent a TT (transverse-transverse) acoustic wave mode. The images 324 were normalized to a highest amplitude in each channel, at a pixel resolution of 256×256 pixels. For the ground truth labeled feature map 334, different color channels can be used to represent the labels. For example, a base metal region 346 can be represented as a blue region, empty space or air can be represented by a green region 342 (such as corresponding to a sidewall), and a red region can represent an SDH 360. The training approach discussed above can be used to establish a generator neural network that produces an output feature map that corresponds to the “ground truth” labeled feature map 334 when provided with input images 324. An output of the generator neural network can use the same color scheme (e.g., three output channels corresponding to three different colors). Pixel values assigned by the generator neural network in the output image (e.g., colors or amplitudes, as illustrative examples) indicate feature locations.

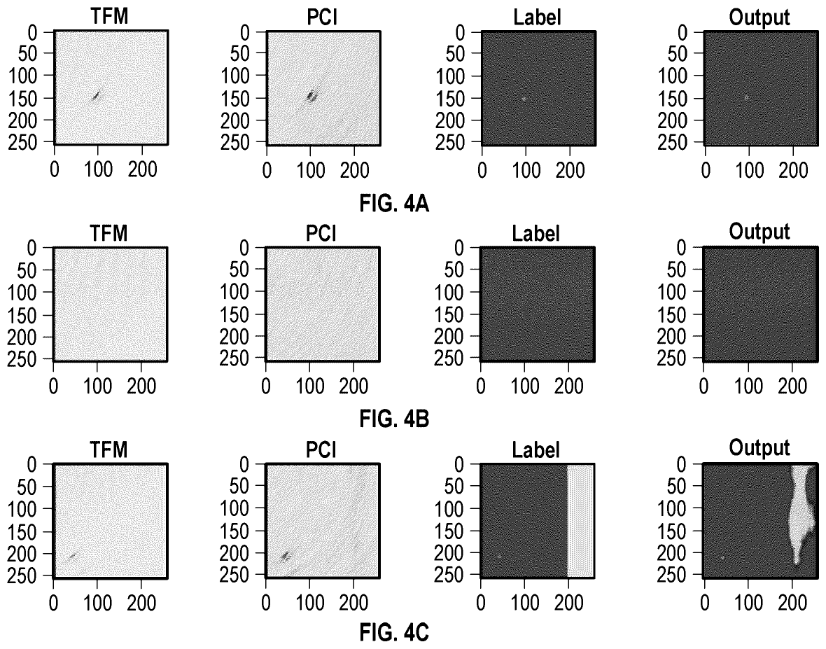

FIG. 4A, FIG. 4B, and FIG. 4C show illustrative examples of input images applied to a trained generator neural network, along with an output feature map from the neural network, and a “ground truth” labeled map for comparison, with FIG. 4A showing a single side-drilled hole (SDH) flaw, matching the labeled map, FIG. 4B showing no flaws, matching the labeled map, and FIG. 4C showing a flaw and a surface boundary in the labeled map, and an imperfect output. The examples of FIG. 4A, FIG. 4B, and FIG. 4C correspond to the geometry of the configuration 300 of FIG. 3A and use of two input images 324 as shown illustratively in FIG. 3B.

The examples of FIG. 4A, FIG. 4B, and FIG. 4C included use of a generator neural network trained using 377 acquisitions corresponding to a testing dataset and 94 acquisitions were used as a validation dataset. Training alternated between updating the discriminator neural network and updating the generator neural network.

The loss functions used were:

$${Loss}_{D} = BCEWithLogitsLoss ( D ( G ( x ) ) , 0 ) + BCEWithLogitsLoss ( D ( y ) , 1 ) ; \\ and$$

$${Loss}_{G} = BCEWithLogitsLoss ( D ( G ( x ) ) , 1 ) + λ \cdot CrossEntropyLoss ( G ( x ) , y )$$

For CrossEntropy Loss, the relative weight for the red, green, and blue (R, G, and B) channels were [10,10,1], respectively. These weights were selected in part because red and green pixels occupy much smaller regions of the label image, when using the labeling color code as mentioned above in relation to FIG. 3B, so the red and green channels have a higher weight than the blue channel. The training was carried through 25 epochs to reach apparent convergence, and the Adam optimizer was used. Other parameters included a batch size of 4, a learning rate of 0.00002, and a lambda (λ) of 20. The examples of FIG. 4A, FIG. 4B, and FIG. 4C show, respectively, that when a single SDH is present, the generator output closely corresponds to the ground truth label, and that when no flaw is present, usually there is no false positive. In the example of FIG. 4C, the SDH flaw is shown correctly, but the sidewall boundary and free-space region to the right of the sidewall are not mapped completely.

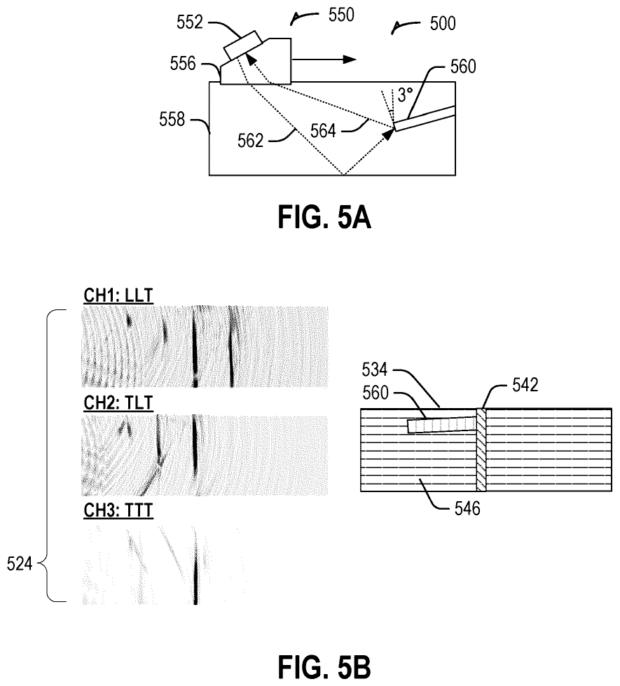

As another illustration, FIG. 5A illustrates generally an inspection configuration 500 for obtaining a training and evaluation data set where a test block 558 comprising a flat-bottomed hole (FBH 560) is used as an object under test. In the example of FIG. 5A, the 560 shown in FIG. 5A of the test block 558 is a 3-mm-diameter FBH having a bottom surface oriented 3° below horizontal. Acoustic inspection data comprised FMC data acquired at one-millimeter intervals of displacement using a probe assembly 550 comprising a 32-element 5L32-A32 probe 552 coupled to a 36.1° SA32-N55S-IHC wedge 556. As discussed below in relation to FIG. 5B, images corresponding to different acoustic wave propagation modes were provided to separate input channels of the generator neural network. The propagation modes are labeled LLT, TLT, and TTT. Referring to FIG. 5A, the first two letters correspond to the mode for the two-segment transmitted acoustic wave path 562, and the last letter corresponds to the scattered or reflected wave path 564. Such modes can also be notated as LL-T, TL-T, and TT-T, respectively.

FIG. 5B shows an illustrative example of acoustic inspection images 524 generated using beamforming corresponding to three different acoustic propagation modes (LLT, TLT, TTT) applied to inspection data acquired from the same object under test, and an associated labeled feature map 534 representative of the actual physical geometry of the object under test from which acoustic inspection data used for the images was acquired. As in the SDH example of FIG. 3B, the images 524 are monochromatic and each normalized to a highest amplitude in each image. A pixel resolution for the input images 524 was 256×768 pixels. Mode conversion artifacts are visible in the input images 524. As in the example of FIG. 3B, the associated labeled feature map 534 can use a color-coded feature mapping where a base metal region 546 is represented as blue, a sidewall interface 542 is represented as green, and red is used to represent an FBH 560. By contrast with the example of FIG. 3B, the sidewall interface 542 does not fill in the free space region to the right in the labeled feature map 534.

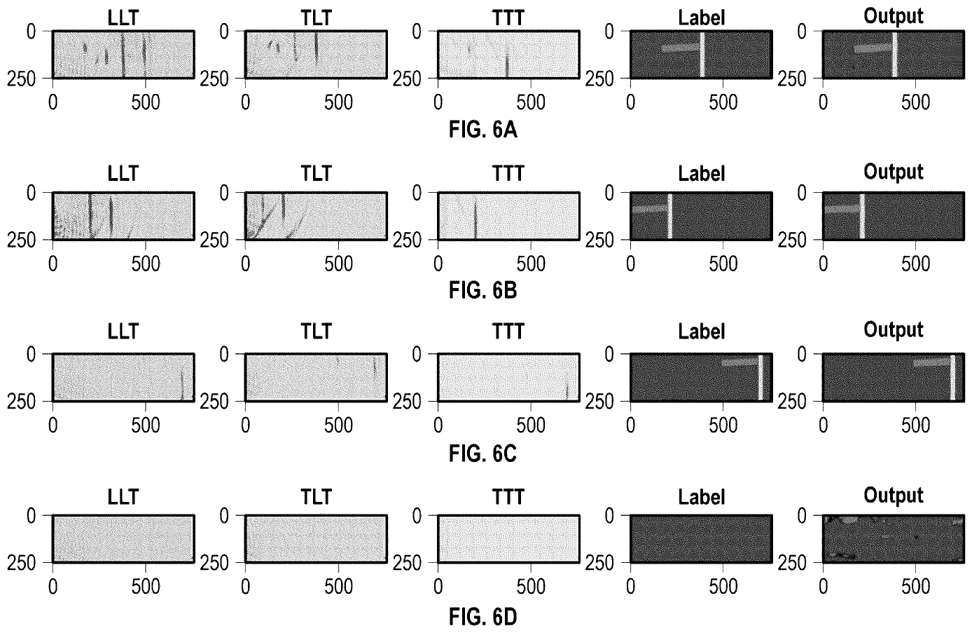

FIG. 6A, FIG. 6B, FIG. 6C, and FIG. 6D show illustrative examples of input images applied to a trained generator neural network, along with an output feature map from the neural network, and a “ground truth” labeled map for comparison, with FIG. 6A, FIG. 6B, and FIG. 6C showing a flat-bottomed hole (FBH) flaw and surface boundary matching the labeled map, and FIG. 6D showing artifacts in the presence of no flaws in the corresponding labeled map. The examples of FIG. 6A, FIG. 6B, FIG. 6C, FIG. 6D correspond to the geometry of the configuration 500 of FIG. 5A and use of three input images 524 as shown illustratively in FIG. 5B. For training the generator neural network of this example, 536 acquisitions were used comprising a testing dataset and 134 acquisitions were used representing a validation dataset. The training was carried through 16 epochs to reach apparent convergence, and the Adam optimizer was used. Other parameters included a batch size of 4, a learning rate of 0.00002, and a lambda (λ) of 20, and class weights of [10, 2, 2].

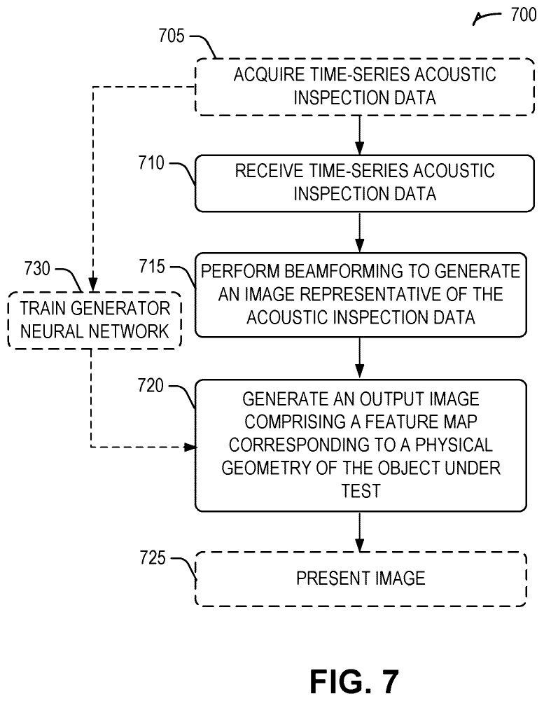

FIG. 7 illustrates generally a technique 700, such as a machine-implemented method, for performing image-to-image translation, such as for generating a feature map corresponding to a physical geometry of an object under test as shown and described in relation to other examples in this document. At 710, time-series acoustic inspection data can be received, such as representative of an FMC acquisition. At 715, a beamforming technique can be applied, such as comprising a delay-and-sum approach to generate an acoustic inspection image. Examples of delay-and-sum approaches including TFM and PCI. Multiple images can be generated at 715 from the same acquired FMC dataset, such as representative of different beamforming modes or different acoustic wave propagation modes, or both. At 720, an output image can be generated, such as using a generator neural network trained using a cGAN topology. The output image can represent a feature map corresponding to a physical geometry of the object under test, where features such as walls, flaws, or material boundaries are shown in spatial locations corresponding to a physical location of such features. At 720, the flaw map can be presented, such as in combination with one or more images generated at 715. The imaging generated using the technique 700 can be stored or transmitted elsewhere for presentation. The technique 700 can be used in applications where imaging is reviewed contemporaneously or shortly after acquisition, or in an off-line approach where image-to-image translation is performed after acquisition, such as using remote compute facilities or other devices separate from an acquisition instrument.

For example, at 705, the acoustic inspection data later received at 710 can be acquired using a test instrument that is separate from another facility used for performing the remainder of the technique 700. As discussed above, acquired time-series acoustic inspection data or associated images generated at 715 can be used to train the generator neural network at 730. Such training can be separate from operational use of the generator neural network in production, or such training can be performed in relation to specified triggering events, such as changes to the object under test geometry, or other criteria.

As mentioned above elsewhere in this document, generation of a feature map need not be restricted to identification of possible flaw locations. Image-to-image translation as shown and described herein can be used, for example, for surface profile mapping, or for identification of boundaries between different materials. As an illustration, a U-net neural network topology can be used for such surface profile mapping, where a binary cross-entropy was used as a loss function. A neural network for performing surface profile may not need to be the same as one used for flaw mapping, and such network can be applied in parallel to an input image and their corresponding results merged. Alternatively, or in addition, such as shown herein, surface profile or interface extraction can be included as an output channel of a feature map provided by a generator neural network, along with possible flaw locations shown by one or more other channels in the output of the generator neural network.

The examples discussed above generally refer to receiving imaging generated using beamforming as an input to a generator neural network, where an output is a feature map. These can be reversed so that a generator neural network is trained to produce a realistic-looking acoustic inspection image (such as corresponding to a TFM image), from a labeled input showing sample geometry and physical flaw locations. This may be useful for establishing synthetic acoustic inspection images for training or other purposes.

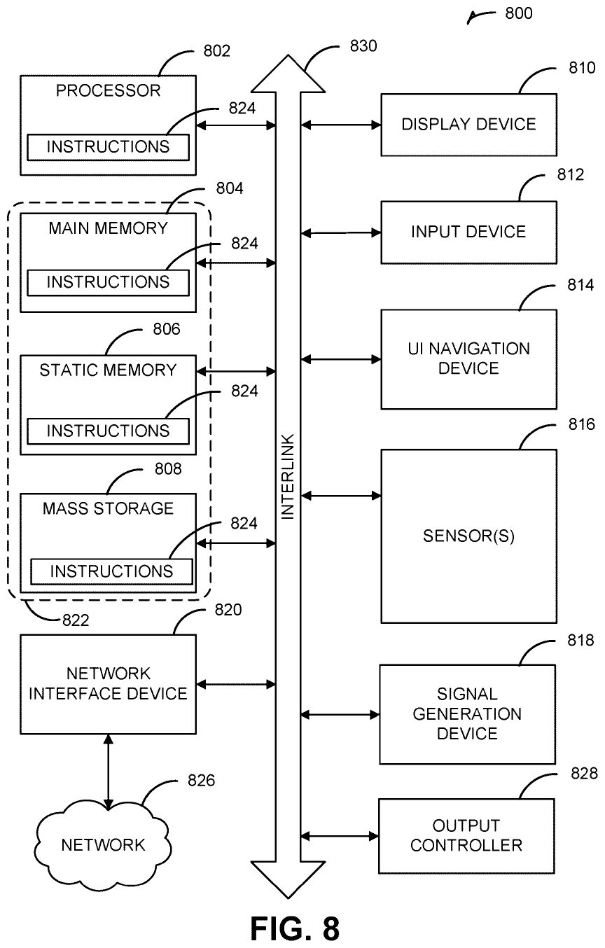

FIG. 8 illustrates a block diagram of an example comprising a machine 800 upon which any one or more of the techniques (e.g., methodologies) discussed herein may be performed. Machine 800 (e.g., computer system) may include a hardware processor 802 (e.g., a central processing unit (CPU), a graphics processing unit (GPU), a hardware processor core, or any combination thereof), a main memory 804 and a static memory 806, connected via an interlink 830 (e.g., link or bus), as some or all of these components may constitute hardware for systems or related implementations discussed above.

Generally, the hardware processor 802 may, for example, include at least one of a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), a Tensor Processing Unit (TPU), a Neural Processing Unit (NPU), a Vision Processing Unit (VPU), a Machine Learning Accelerator, an Artificial Intelligence Accelerator, an Application Specific Integrated Circuit (ASIC), a Field Programmable Gate Array (FPGA), a Radio-Frequency Integrated Circuit (RFIC), a Neuromorphic Processor, a Quantum Processor, or any combination thereof. A processor circuit may further be a multi-core processor having two or more independent processors (sometimes referred to as “cores”) that may execute instructions contemporaneously. Multi-core processors contain multiple computational cores on a single integrated circuit die, each of which can independently execute program instructions in parallel. Parallel processing on multi-core processors may be implemented via architectures like superscalar, VLIW, vector processing, or SIMD that allow each core to run separate instruction streams concurrently. A processor circuit may be emulated in software, running on a physical processor, as a virtual processor or virtual circuit. The virtual processor may behave like an independent processor but is implemented in software rather than hardware.

Specific examples of main memory 804 include Random Access Memory (RAM), and semiconductor memory devices, which may include storage locations in semiconductors such as registers. Specific examples of static memory 806 include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; or optical media such as CD-ROM and DVD-ROM disks.

The machine 800 may further include a display device 810, an input device 812 (e.g., a keyboard), and a user interface (UI) navigation device 814 (e.g., a mouse). In an example, the display device 810, input device 812, and UI navigation device 814 may be a touch-screen display. The machine 800 may include a mass storage device 808 (e.g., drive unit), a signal generation device 818 (e.g., a speaker), a network interface device 820, and one or more sensors 816, such as a global positioning system (GPS) sensor, compass, accelerometer, or some other sensor. The machine 800 may include an output controller 828, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The mass storage device 808 may comprise a machine-readable medium 822 on which is stored one or more sets of data structures or instructions 824 (e.g., software) embodying or utilized by any one or more of the techniques or functions described herein. The instructions 824 may also reside, completely or at least partially, within the main memory 804, within static memory 806, or within the hardware processor 802 during execution thereof by the machine 800. In an example, one or any combination of the hardware processor 802, the main memory 804, the static memory 806, or the mass storage device 808 comprises a machine readable medium.

Specific examples of machine-readable media include, one or more of non-volatile memory, such as semiconductor memory devices (e.g., EPROM or EEPROM) and flash memory devices; magnetic disks, such as internal hard disks and removable disks; magneto-optical disks; RAM; or optical media such as CD-ROM and DVD-ROM disks. While the machine-readable medium is illustrated as a single medium, the term “machine readable medium” may include a single medium or multiple media (e.g., a centralized or distributed database, or associated caches and servers) configured to store the one or more instructions 824.

An apparatus of the machine 800 includes one or more of a hardware processor 802 (e.g., a central processing unit (CPU), a graphics processing unit (GPU), a hardware processor core, or any combination thereof), a main memory 804 and a static memory 806, sensors 816, network interface device 820, antennas, a display device 810, an input device 812, a UI navigation device 814, a mass storage device 808, instructions 824, a signal generation device 818, or an output controller 828. The apparatus may be configured to perform one or more of the methods or operations disclosed herein.

The term “machine readable medium” includes, for example, any medium that is capable of storing, encoding, or carrying instructions for execution by the machine 800 and that cause the machine 800 to perform any one or more of the techniques of the present disclosure or causes another apparatus or system to perform any one or more of the techniques, or that is capable of storing, encoding or carrying data structures used by or associated with such instructions. Non-limiting machine-readable medium examples include solid-state memories, optical media, or magnetic media. Specific examples of machine-readable media include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); or optical media such as CD-ROM and DVD-ROM disks. In some examples, machine readable media includes non-transitory machine-readable media. In some examples, machine readable media includes machine readable media that is not a transitory propagating signal.

The instructions 824 may be transmitted or received, for example, over a communications network 826 using a transmission medium via the network interface device 820 utilizing any one of a number of transfer protocols (e.g., frame relay, internet protocol (IP), transmission control protocol (TCP), user datagram protocol (UDP), hypertext transfer protocol (HTTP), etc.). Example communication networks include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®), IEEE 802.15.4 family of standards, a Long Term Evolution (LTE) 4G or 5G family of standards, a Universal Mobile Telecommunications System (UMTS) family of standards, peer-to-peer (P2P) networks, satellite communication networks, among others.

In an example, the network interface device 820 includes one or more physical jacks (e.g., Ethernet, coaxial, or other interconnection) or one or more antennas to access the communications network 826. In an example, the network interface device 820 includes one or more antennas to wirelessly communicate using at least one of single-input multiple-output (SIMO), multiple-input multiple-output (MIMO), or multiple-input single-output (MISO) techniques. In some examples, the network interface device 820 wirelessly communicates using Multiple User MIMO techniques. The term “transmission medium” shall be taken to include any intangible medium that is capable of storing, encoding or carrying instructions for execution by the machine 800, and includes digital or analog communications signals or other intangible medium to facilitate communication of such software.

### Various Notes

Each of the non-limiting aspects in this document can stand on its own or can be combined in various permutations or combinations with one or more of the other aspects or other subject matter described in this document.

The above detailed description includes references to the accompanying drawings, which form a part of the detailed description. The drawings show, by way of illustration, specific embodiments in which the invention can be practiced. These embodiments are also referred to generally as “examples.” Such examples can include elements in addition to those shown or described. However, the present inventor also contemplates examples in which only those elements shown or described are provided. Moreover, the present inventor also contemplates examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc., are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Such instructions can be read and executed by one or more processors to enable performance of operations comprising a method, for example. The instructions are in any suitable form, such as but not limited to source code, compiled code, interpreted code, executable code, static code, dynamic code, and the like. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A machine-implemented method for generation of a feature map from acoustic beamforming imaging, the machine-implemented method comprising:
receiving time-series acoustic inspection data representing acoustic echo signals acquired in response to insonifying an object under test;
performing beamforming to generate an image representative of the acoustic inspection data; and
applying the image as an input to a channel of a generator neural network and, using the generator neural network, generating an output image comprising a feature map corresponding to a physical geometry of the object under test.

2. The machine-implemented method of claim 1, wherein the applying the image as an input to a channel comprises applying different input images representative of the object under test as inputs to different color channels of the generator neural network.

3. The machine-implemented method of claim 2, wherein the different input images comprise an image defining pixel values generated using a Total Focusing Method (TFM) and an image defining pixel values generated using Phase Coherence Imaging (PCI).

4. The machine-implemented method of claim 2, wherein the different input images represent different acoustic propagation modes.

5. The machine-implemented method of claim 1, wherein the feature map is defined by assigning pixel values that indicate a physical location of a possible flaw.

6. The machine-implemented method of claim 5, wherein a specified pixel color is assigned to indicate a physical location of a possible flaw.

7. The machine-implemented method of claim 5, wherein the feature map is defined by assigning pixel values that indicate a physical location of a surface profile or a material boundary.

8. The machine-implemented method of claim 7, wherein different pixel colors are assigned depending on whether a pixel location corresponds to a possible flaw versus a material boundary or a surface.

9. The machine-implemented method of claim 1, wherein the generator neural network is trained using a conditional Generative Adversarial Network (cGAN) topology comprising the generator neural network and a discriminator neural network.

10. The machine-implemented method of claim 9, wherein the cGAN topology is trained using input images generated using beamforming and corresponding feature maps.

11. The machine-implemented method of claim 10, wherein the feature maps are labeled by assigning different colors to different features.

12. The machine-implemented method of claim 11, wherein a weight of a red color channel corresponding to labeled flaw regions is higher than other color channels.

13. The machine-implemented method of claim 9, wherein the cGAN topology is trained using imaging corresponding to an object having a same geometry as the object under test.

14. The machine-implemented method of claim 1, comprising presenting the feature map as an image.

15. A system, comprising:
at least one processor circuit communicatively coupled with at least one memory circuit comprising instructions that, when executed by the at least one processor circuit, cause the system to perform a machine-implemented method, comprising:
receiving time-series acoustic inspection data representing acoustic echo signals acquired in response to insonifying an object under test;
performing beamforming to generate an image representative of the acoustic inspection data; and
applying the image as an input to a channel of a generator neural network and, using the generator neural network, generating an output image comprising a feature map corresponding to a physical geometry of the object under test.

16. The system of claim 15, comprising:
a test instrument; and
an acoustic probe assembly communicatively coupled to the test instrument.

17. The system of claim 16, wherein the at least one processor circuit and the at least one memory circuit comprising the instructions are located remotely with respect to the probe assembly.

18. The system of claim 16, wherein the at least one processor circuit and the at least one memory circuit comprising the instructions are included as a portion of the test instrument.

19. A system for generation of a feature map from acoustic beamforming imaging, the system comprising:
a means for receiving time-series acoustic inspection data representing acoustic echo signals acquired in response to insonifying an object under test;
a means for performing beamforming to generate an image representative of the acoustic inspection data; and
a means for applying the image as an input to a channel of a generator neural network and, using the generator neural network, generating an output image comprising a feature map corresponding to a physical geometry of the object under test.

20. The system of claim 19, wherein the means for applying the image as an input to a channel comprises a means applying different input images representative of the object under test as inputs to different channels of the generator neural network; and
wherein the different input images represent different acoustic propagation modes or are constructed using different beamforming approaches, or both.
